(19) United States
(12) Patent Application Publication
(10) Pub. No.: US 2022/0398278 A1
(43) Pub. Date: Dec. 15, 2022

(54) DATA ANALYSIS

(71) Applicant: BAE Systems plc, London (GB)

(72) Inventor: Simon Bishop, Christchurch, Dorset (GB)

(73) Assignee: BAE Systems plc, London (GB)

(21) Appl. No.: 17/763,062

(22) PCT Filed: Sep. 17, 2020
(86) PCT No.: PCT/GB2020/052244

§ 371 Date: Mar. 23, 2022

(30) Foreign Application Priority Data
Oct. 8, 2019 (GB) 1914492.2

(51) Int. Cl. G06F 16/58; G06F 21/62

(52) U.S. Cl. CPC G06F 16/5866; G06F 21/62

(57) ABSTRACT

The present invention provides a presenting device and analytics device. The presenting device comprises a storage means comprising first data and second data, wherein the first data is of a higher security classification than the second data; a controller configured to generate a first computer-readable tag based on the second data; and image generation means configured to generate an image for display on a display apparatus, the image comprising the first data and the first computer-readable tag. The analytics device comprises a reader for reading the computer-readable tag and a controller for decoding the computer-readable tag and identifying data associated therewith. The present invention also provides a system comprising the presenting device and an analytics device and a methods of presenting and analysing data.

### FIELD OF THE INVENTION

The present invention relates to a presenting device, analytics device and a system for presenting and analysing data. The present invention also relates to a method of presenting data, method of analysing data, and method of presenting and analysing data.

### BACKGROUND

It is known to provide information of mixed classification to force commanders on a screen coupled to a secure computing device. Some of the information in this mixed information, or its underlying data, is secure (i.e. controlled in accordance with a government security classification such as SECRET, TOP SECRET, RESTRICTED, UK EYES ONLY). However, aspects of the presented information, or its underlying data, will not be detrimental to the security of the information, and it would be desirable to analyse this non-detrimental information or data using an unsecure computing device.

For example, the specific geographical location (i.e. location on a map) of two groups of special forces, each carrying a radio, will be secure information. However, the fact there is a communications node displaced a particular distance from another communications node, agnostic to the specific geography or nature of the node operator, is information that need not be classified as it would not compromise the special forces mission. The computing device of an operator tasked with optimising the network, along with the operator themselves, may have a lower security clearance than the computing device projecting the classified mission information to force commanders.

Therefore, there is a need for an apparatus for analysing data without compromising the secure data with which it is embedded.

### SUMMARY

According to a first aspect of the present invention, there is provided a presenting device comprising:
a storage means comprising first data and second data, wherein the first data is of a higher security classification than the second data;
a controller configured to generate a first computer-readable tag based on the second data; and
image generation means configured to generate an image for display on a display apparatus, the image comprising the first data and the first computer-readable tag.

Advantageously, the presenting device presents data in such a way that allows unclassified data, presented with classified data, to be viewed on a device not permitted to read the classified data.

The image generation means may be arranged to substantially co-locate the first data and the first computer-readable tag on the display apparatus.

The image generation means may comprise a projector for projecting the first computer-readable tag on to the display apparatus.

The first data may comprise map coordinates for an asset, and the image may comprise a map having the asset and first computer-readable tag displayed thereon.

The controller may be configured to generate a second computer-readable tag representing the scale of the map in the image, and the image may comprise the second computer-readable tag.

The second data may comprise communication equipment data for the asset and/or the type of asset.

The first computer-readable tag may be based on a unique record locator for the second data within a database. Alternatively, the first computer-readable tag may be an encoded text string representing the second data.

According to a second aspect of the present invention, there is provided an analytics device comprising:
a reader for reading a plurality of computer-readable tags from a first display apparatus;
storage means for storing the relative location of each of the computer-readable tags on the first display apparatus;
a controller configured to decode the plurality of computer-readable tags and identify data associated therewith; and
a second display apparatus for displaying the data and the relative location of the computer-readable tags.

At least one computer-readable tag may be an encoded representation of a map scale, and the controller may be configured to determine the represented distance between the computer-readable tags based on the map scale.

The data may be communications network management data.

According to a third aspect of the present invention, there is provided a system for presenting and analysing data, the system comprising:
the presenting device according to the first aspect for displaying first data and at least one computer-readable tag on a display apparatus, the first data having a higher security classification than second data on which the computer-readable tag is based; and
an analytics device comprising:
   a reader for reading the at least one computer-readable tag from the display apparatus; and
   a controller configured to decode the at least one computer-readable tag, identify data associated therewith and display the data.

The analytics device may comprise the analytics device according to the second aspect.

According to a fourth aspect of the present invention, there is provided a method of presenting secure data, the method comprising:
storing first data and second data, wherein the first data is of a higher security classification than the second data;
generating a first computer-readable tag based on the second data; and
generating an image for display on a display apparatus, the image comprising the first data and the first computer-readable tag.

The method may comprise co-locating the first data and the first computer-readable tag on the display apparatus.

The method may comprise projecting the first computer-readable tag on to the display apparatus.

The first data may comprise map coordinates for an asset, and the image may comprise a map having the asset and first computer-readable tag displayed thereon.

The method may comprise generating a second computer-readable tag representing the scale of the map in the image, and the image may comprise the second computer-readable tag.

According to a fifth aspect of the present invention, there is provided a method of analysing data, the method comprising:
reading a plurality of computer-readable tags from a first display apparatus;
storing the relative location of each of the computer-readable tags on the first display apparatus;
decoding the plurality of computer-readable tags and identifying data associated therewith; and
displaying the data and the relative location of the computer-readable tags.

The method may comprise determining the represented distance between the computer-readable tags based on a map scale, wherein at least one computer-readable tag is an encoded representation of the map scale.

According to a sixth aspect of the present invention, there is provided a method of presenting and analysing data, the method comprising:
displaying first data and at least one computer-readable tag on a display apparatus, the first data having a higher security classification than second data on which the computer-readable tag is based;
reading the at least one computer-readable tag from the display apparatus; and
decoding the at least one computer-readable tag, identifying data associated therewith and displaying the data.

The method may comprise the method of analysing data according to the fifth aspect.

It will be appreciated that features described in relation to one aspect of the present invention can be incorporated into other aspects of the present invention. For example, an apparatus of the invention can incorporate any of the features described in this disclosure with reference to a method, and vice versa. Moreover, additional embodiments and aspects will be apparent from the following description, drawings, and claims. As can be appreciated from the foregoing and following description, each and every feature described herein, and each and every combination of two or more of such features, and each and every combination of one or more values defining a range, are included within the present disclosure provided that the features included in such a combination are not mutually inconsistent. In addition, any feature or combination of features or any value(s) defining a range may be specifically excluded from any embodiment of the present disclosure.

### BRIEF DESCRIPTION OF THE DRAWINGS

Embodiments of the invention will now be described by way of example only and with reference to the accompanying drawings.

FIG. 1 is a system diagram of a data analysis system according to embodiments of the present invention;

FIG. 2 is a system diagram of classified presentation apparatus according to embodiments of the present invention;

FIG. 3 is a system diagram of a data analysis apparatus according to embodiments of the present invention;

FIG. 4 is an orthogonal view of a classified display according to embodiments of the present invention;

FIG. 5 is an orthogonal view of an unclassified display according to embodiments of the present invention; and

FIG. 6 is a flowchart showing a method of analysing data according to embodiments of the present invention.

For convenience and economy, the same reference numerals are used in different figures to label identical or similar elements.

### DETAILED DESCRIPTION

Generally, embodiments herein relate to components of a system for analysing data. More specifically, mixed information is presented in such a way that data not detrimental to its security can be extracted using a data analysis apparatus. Secure (or classified) information is presented on a display along with computer-readable tags, such as QR codes™ or barcodes. The computer-readable tags are associated with unclassified data. A non-secure (or unclassified) reader is used to read the computer-readable tags, determine the associated unclassified data and generate unclassified information for display on a non-secure (or unclassified) device.

Herein, “data” is generally used to refer to content used to generate meaningful information. However, the present invention can be used to analyse either data or information, and therefore the terms should be considered interchangeable. For example, the computer-readable tags themselves may not have any meaning to a human observer, but they are presented on a display along with information, and are linked to a lookup table having information that would be understandable and useful for a network optimiser. Also, the positioning of the computer-readable tags on the display would have meaning to the operator, and therefore, the computer-readable tags can be information, data, or both.

The invention will now be explained in more detail with reference to the drawings.

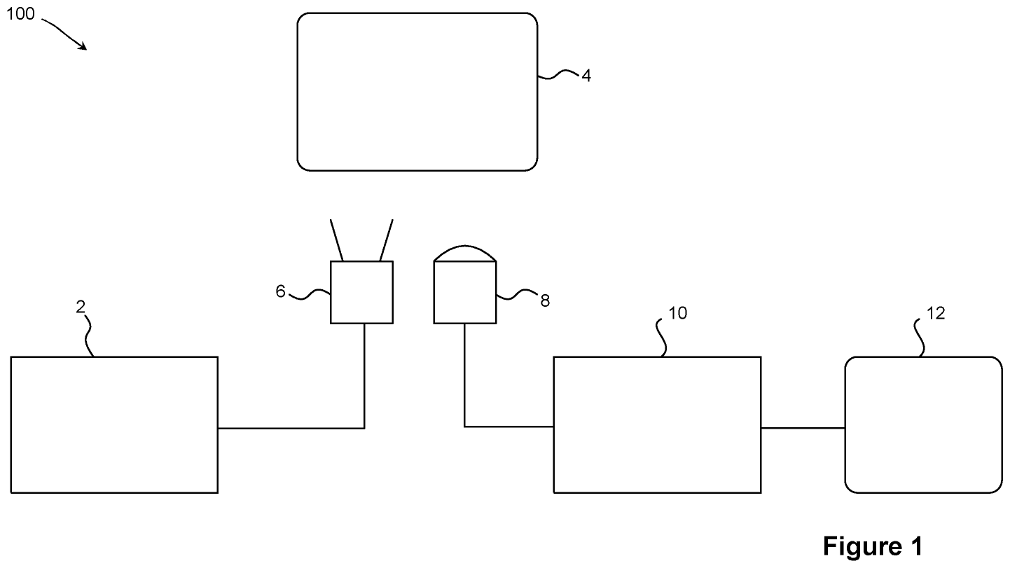

FIG. 1 shows a system 100 for analysing data according to embodiments of the invention. The system 100 includes a presenting device 2; a main display 4 for receiving classified data (and/or information) and computer-readable tags representative of unclassified data from the presenting device 2 and displaying it to a first user; an analytics device 10 for reading the computer-readable tags using a reader 8 and processing the computer-readable tags; and an analytics display 12 which a second user, not having security clearance, can use to analyse the unclassified data (and/or information) represented by the computer-readable tags. Instead of only classified data, mixed data (i.e. classified data and unclassified data) may be presented on the main display 4 along with the computer-readable tags.

In other words, the analytics device 10 has a lower security grading than the presenting device 2. For example, the presenting device 2 may be cleared up to SECRET, while the analytics may be UNCLASSIFIED or only cleared up to OFFICIAL SENSITIVE. Due to security restrictions and the threat of hacking, the presenting device 2 is unable to interface directly with the analytics device 10 or the main display 4 having classified data displayed thereon.

In the illustrated embodiment, the presenting device 2 is coupled to a projector 6 for projecting the classified data and computer-readable tags onto the main display 4. Here, the main display 4 is an unpowered screen. In another embodiment, the presenting device 2 is coupled directly to the main display 4 via a video transmission cable. In this other embodiment, the main display 4 is an LED or LCD display, such as a television or computer monitor. The video transmission cable is, for example, a HDMI cable, USB cable or VGA cable. In both of the preceding embodiments, the classified data and computer-readable tags are integrated into the same transmission data prior to display. In some embodiments, the presenting device 2 is coupled to the main display 4 such that the classified data is transmitted to the main display 4 via the wired connection and the projector 6 is used to project computer-readable tags over the classified data. In other words, the computer-readable tags are overlaid onto the classified data but are isolated therefrom.

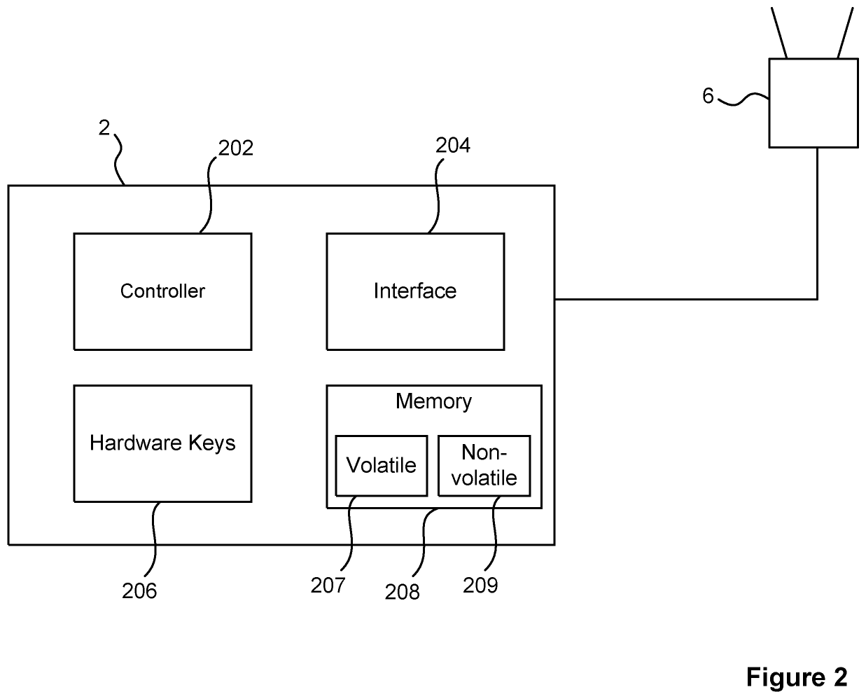

The presenting device 2 is shown in more detail in FIG. 2. Here, the presenting device 2 includes a controller 202, hardware keys 206, memory 208 and an interface 204. In the illustrated embodiment, the presenting device 2 is coupled to a projector 6 through the interface 204. In other embodiments, the presenting device 2 is coupled alternatively or additionally to the main display 4 by a wired connection. In a further embodiment, the projector 6 may be integrated with the presenting device 2. The presenting device 2 may be, for example, a desktop computer, server, mobile phone or tablet computer.

The controller 202 may take any suitable form. For instance, it may be a microcontroller, plural microcontrollers, a processor, or plural processors.

The memory 208 includes a non-volatile memory 209 such as read only memory (ROM), a hard disk drive (HDD) or a solid state drive (SSD). The non-volatile memory 209 stores, amongst other things, an operating system and software applications. One software application is provided to encode data into computer-readable tags for presenting on the main display 4. These tags, in the illustrated embodiment, are presented on the main display 4 by the projector 6. The memory 208 also includes volatile memory 207 such as random access memory (RAM). The RAM is used by the controller 202 for the temporary storage of data. The operating system may contain code which, when executed by the controller 202 in conjunction with RAM, controls operation of each of hardware components of the presenting device 2.

In one embodiment, the non-volatile memory 209 further includes a database for storing classified and unclassified data. The unclassified data may include a list of asset types. The unclassified data may further include the communication equipment associated with those asset types. The classified data may include the offensive or defensive capability of those asset types and/or their real-world location. The unclassified data may include biomedical data, such as the heart rate of a soldier, or whether they have an injury. In alternative embodiments, the database is separate from the presenting device 2 and accessed via the interface 204.

The interface 204 is a data input/output, which allows the presenting device 2 to communicate with other devices, such as external storage media. The interface 204 may be a wired interface such as a USB, HDMI, Ethernet or DisplayPort adapter. The interface 204 may also be a wireless interface, such as Bluetooth™ or WiFi.

The hardware keys 206 may include a keyboard, mouse and/or joystick for allowing a user to control the presenting device 2. For example, the hardware keys 206 enable an image displayed on the main display 4 to be panned, tilted or zoomed. The presenting device 2 may further or alternatively include a touch screen display for providing the user the ability to control the presenting device 2.

The presenting device 2 includes a power supply (not shown). The power supply may be a mains AC supply, or may comprise a battery.

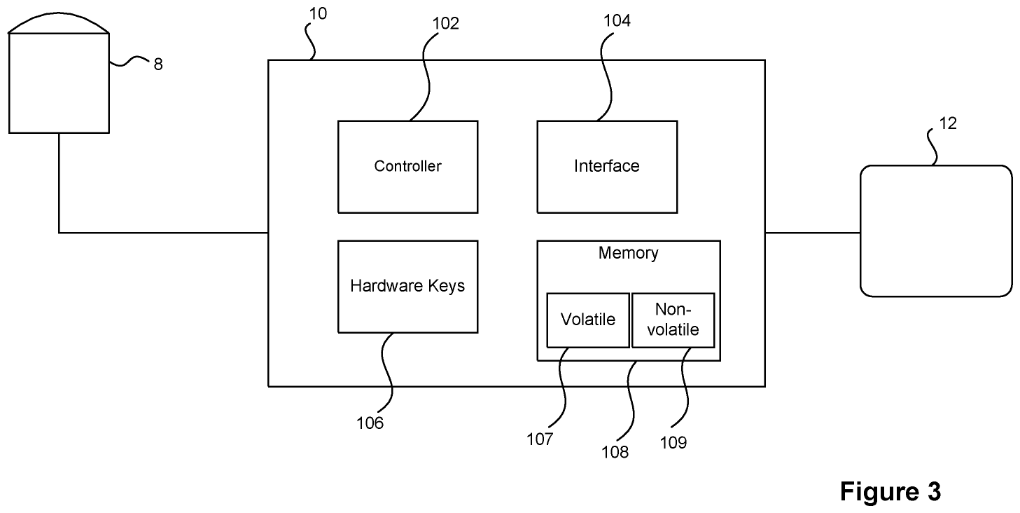

The analytics device 10 is shown in more detail in FIG. 3. The analytics device 10 is configured similarly to the presenting device 2, but is assigned a lower security classification. In other words, the analytics device 10 is not configured, or cleared, to receive classified data. The analytics device 10 may be a network configuration or management device. The analytics device 10 may be, for example, a desktop computer, mobile phone, or tablet computer.

The analytics device 10, in one embodiment, is for network monitoring and configuration. Therefore, here the analytics device 10 does not need to know anything about the purpose or capability of military assets; but it would be advantageous for it to know the type of communication equipment assigned to those assets, the bandwidth of that communication equipment, and the relative location thereof.

The analytics device 10 includes a controller 102, hardware keys 106, memory 108 and an interface 104. In the illustrated embodiment, the analytics device 10 is coupled to a reader 8 through the interface 104. The analytics device 10 is also coupled to an analytics display 12. In other embodiments, analytics display 12 is integrated with the analytics device 10. The analytics display 12 may be an LED or LCD display, such as a television monitor or computer monitor. The analytics display 12 may be a touchscreen display for controlling the analytics device 10. In other embodiments, the analytics device 10 is coupled to a projector for presenting unclassified data onto an unpowered screen.

The controller 102 may take any suitable form. For instance, it may be a microcontroller, plural microcontrollers, a processor, or plural processors.

The memory 108 includes a non-volatile memory 109 such as read only memory (ROM), a hard disk drive (HDD) or a solid state drive (SSD). The non-volatile memory 109 stores, amongst other things, an operating system and software applications. One software application is provided to decode computer-readable tags read by the reader 8. The decoded data is either further processed by the controller 102 or displayed on the analytics display 12. The memory 108 also includes volatile memory 107 such as random access memory (RAM). The RAM is used by the controller 102 for the temporary storage of data. The operating system may contain code which, when executed by the controller 102 in conjunction with RAM, controls operation of each of hardware components of the analytics device 10.

In one embodiment, the non-volatile memory 109 further includes a database for storing unclassified data. The unclassified data may include a list of asset types. The unclassified data may further include the communication equipment associated with those asset types. In alternative embodiments, the database is separate from the analytics device 10 and accessed via the interface 104. The database may be identical to that associated with the presenting device 2. The order of data entries (e.g. asset names) within the database may be the same as that associated with the presenting device 2, such that a unique pointer or record locator can be used by the presenting device 2 to point to the appropriate data entry in the analytics device 2. Alternatively, the database may be keyword-searchable. The database may include the same data entries as the database associated with the presenting device 2, but have further data associated with each entry. For example, while both databases may list asset types, the database associated with the presenting device 2 may list offensive/defensive capabilities and callsigns associated with those asset types, while the database associated with the analytics device 100 may list network management information associated with those asset types.

In one embodiment, the non-volatile memory 109 is further used to store the location of each computer-readable tag 40 on the main display 4, such that their relative location can be represented on the analytics display 12. Based on relative on-screen locations and the scale of the map (or image generally), the real-world distance between assets 42 can calculated, if the assets 42 are co-located with the computer-readable tags 40 or if each computer-generated tag 40a-c is disposed an identical distance from each respective asset 42a-c on the main display 4.

The interface 104 is a data input/output, which allows the analytics device 10 to communicate with other devices, such as external storage media. The interface 104 may be a wired interface such as a USB, HDMI, Ethernet or DisplayPort adapter. The interface 104 may also be a wireless interface, such as Bluetooth™ or WiFi.

The hardware keys 106 may include a keyboard, mouse and/or joystick for allowing a user to control the analytics device 10. The analytics device 10 may further or alternatively include a touch screen display for providing the user the ability to control the analytics device 10.

The analytics device 10 includes a power supply (not shown). The power supply may be a mains AC supply, or may comprise a battery.

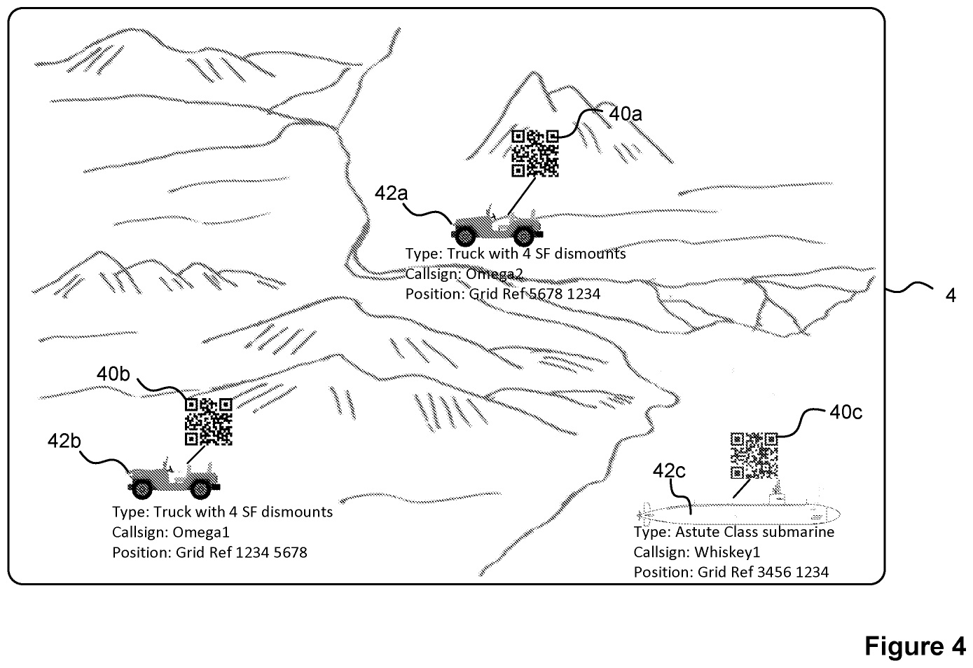

An example of mixed data projected on (or transmitted to) the main display 4 is shown in FIG. 4. Here, a map is displayed. The map itself may be classified data, as it would be advantageous to an enemy to know their country is being targeted in some way. Assets 42a-c (generally 40) along with metadata associated with the assets 42 are overlaid on or integrated with the map. The assets 42 are, for example, military vehicles, equipment or personnel. The metadata describes the assets 42; for example, the assets' capability, type, exact location, or identifier. Some or all of this metadata may be classified, as it would give an enemy an advantage; equally, some of the metadata may be meaningless to an enemy and therefore not classified.

Further, there may be data relating to the assets 42 which is not displayed, such as the type of communications equipment or the capability of the communications equipment present on the assets 42. Some this non-displayed data may also be unclassified.

The presenting device 2 generates computer-readable tags 40a-c (generally, 40) for display in proximity to each asset 42a-c Each asset 42a-c may be associated with a different computer-readable tag 40a-c In one embodiment, each asset 42a-c is associated with more than one computer-readable tag 40. Each computer-readable tag 40 may be associated with a different piece of unclassified data. As illustrated, the computer-readable tags 40 are Quick Response (QR) Codes™. Instead, the computer-readable tags 40 may be any form of computer-readable tags known in the art, such as barcodes, SnapTags or SPARQCODEs™. The computer-readable tags 40 are graphical representations of links to the unclassified data. For example, reading and decoding the computer-readable tags 40 may present a unique record locator (URL) for identifying a specific piece of data in a database known to both the presenting device 2 and the analytics device 10.

In one embodiment, as illustrated, the presenting device 2 generates a QR Code™ 40a that represents a particular type of asset (e.g. a truck) 42a. The existence of a truck in a non-specific location is not classified information. The QR Code™ 40a is an encoded URL that points to the entry for the truck 42a in a database known to the analytics device 10. Therefore, the presenting device 2 has knowledge of the positioning of data items, or another form of unique identifier for data items, in the database known to the analytics device 10. By looking up the entry in the database, the analytics device 10 can read the communications equipment stored in the database as being associated with the truck 42a. Alternatively, the presenting device 2, knowing the communications equipment on board the asset 42a, may encode the URL pointing to the communications equipment in the database known to the analytics device 10. Alternatively again, the presenting device 2 may encode a text string which describes the unclassified information, such as the name of the communications equipment, into a computer-readable tag 40a which can be decoded and subsequently searched for using the analytics device 10.

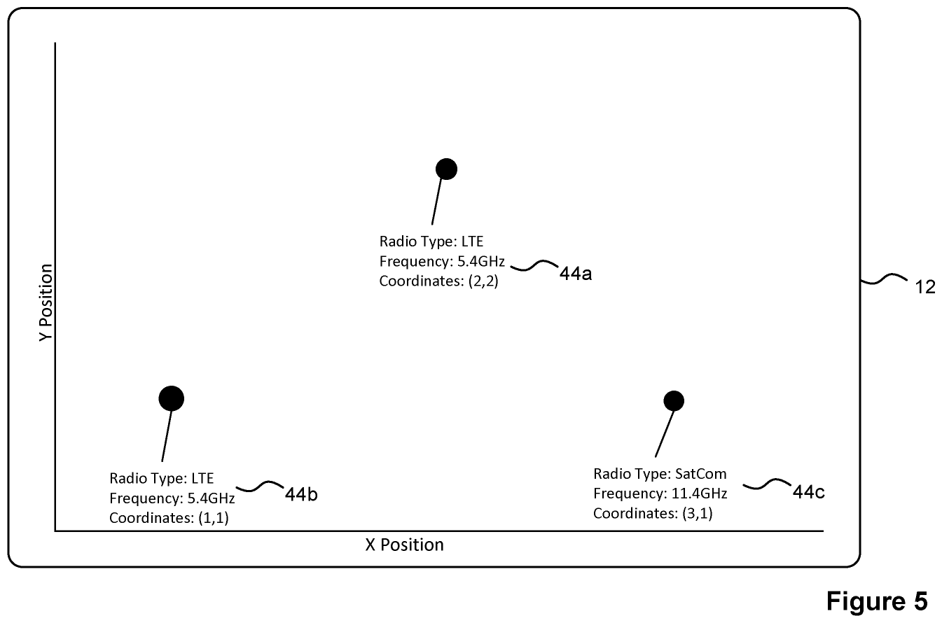

An example of unclassified data 44a-c (generally 44) presented on the analytics display 12 is shown in FIG. 5. Here, the computer-readable tags 40 have been decoded by the analytics device 10, and the data 44a-c represented by each respective tag 40a-c has been identified, processed and presented on the analytics display 12. As the real-world location of the assets 42a-c is classified, the analytics device 10 determines the relative locations of each of the computer-readable tags 40a-c detected by the reader 8 and presents the unclassified data 44a-c in corresponding relative locations on the analytics display 12. For example, while the fact that British military assets are present in the south west of Oman may be classified, the fact that there is a radio having a particular bandwidth on the bottom left of the main display 4 is not classified. It is advantageous for the analytics device 10 to know the scale of the map on the main display 4, such that a corresponding scale can be used when determining the artificial location of the unclassified data 44a-c on the analytics display 12.

In the illustrated embodiment, the unclassified data 44 presented on the analytics display 12 is the type of radio and its frequency, and the location of the radio in the arbitrary coordinate system. In some embodiments, it may be the case that only one piece of unclassified data 44a-c, such as radio type, or asset type, is required from the presenting device 2 in order to generate several items of unclassified data, such as frequency and bandwidth. Generally, network management data, agnostic of real-world coordinates, is considered unclassified data, as its disclosure to an enemy would tend not to compromise a mission. Other, alternative or additional, unclassified data could include the asset name, callsign or type, network capacity, domain data, network configuration data, temperature of the communications equipment, throughput, quality of service (QoS), for example, depending on the situation. Most, if not all of this unclassified data 44, may be known by the analytics device 10 by other means, such as by communicating directly with the asset 42a-c or from other databases. However, the relative positions of the unclassified data 44a-c may be obtainable only by extracting data from the main display 4.

In one embodiment, the analytics display 12 and main display 4 are the same device. In other words, in this embodiment, the unclassified data, such as network management data, is projected back on to the main display 4 from which it was extracted.

In another embodiment, the unclassified data 44 is listed on the analytics display 12, without its location being represented. The real-world distance between the assets 42 may be calculated and displayed as part of the unclassified data 44. The real-world distance is calculated using the scale of the map and relative locations of the computer-generated tags 40, where the computer-generated tags 40 are co-located with the assets 42 on the main display 42 or where each computer-generated tag 40a-c is disposed an identical distance from each respective asset 42a-c.

Advantageously, by being able to process network management data on an unclassified analytics device 12, the internet can be used to configure or manage the network.

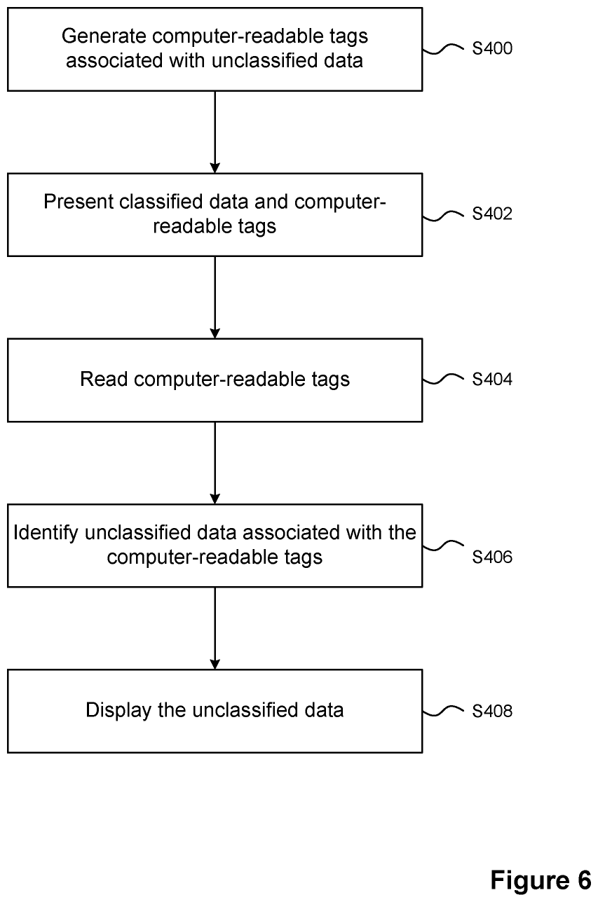

A method of extracting and analysing unclassified data 44 is shown in FIG. 6. Here, using this method, a device 10 not permitted to read classified data is able to read unclassified data 44 presented alongside classified data. In a first step, S400, the presenting device 2 is arranged to generate computer-readable tags 40 associated with unclassified data 44. In other words, a computer, physically isolated from the presenting device 2, can use the computer-readable tags 40 to identify and process the unclassified data 44.

The unclassified data 44 may be extracted from mixed data using a lookup table. For example, a database accessible by the presenting device 2 may indicate that a particular type of asset 42 such as a vehicle, has a particular type of radio on board. In another embodiment, the presenting device 2 transmits e.g. the name of the particular type of asset 42 to the analytics device 10, which in turn determines further unclassified data 44 relating to that type of asset, such as the particular type of communications equipment on board. The URL for pointing the analytics device 10 to the location of a record of unclassified data in the database is then encoded into an image of a known format, such as a QR Code™, which can be read by a reader 8.

In another embodiment, the computer-readable tags 44 are generated by converting the unclassified data 44 into a text string, then encoding the text string into an image of a known format, such as a QR Code™. When the image (i.e. computer-readable tag 40) is decoded, the text string is obtained by the analytics device 10. The unclassified text string may be, for example, “[asset type]” or “[radio type];[radio frequency]” or “[gunshot wound]”.

In a second step, S402, the classified data, such as the real-world location, status or capability of assets 42 is presented on the main display 4 along with the generated computer-readable tags 40. Preferably, the computer-readable tags 40, and the assets 42 they are associated with, are co-located on the main display 4. In some embodiments, the computer-readable tags 40 and the classified data are embedded together in the same transmission. In other embodiments, the computer-readable tags 40 are overlaid on top of presented classified data using a projector 6. The presenting device 2 is configured to determine the location of the assets 42 and move each projected computer-readable tag 40a-c to be co-located with the respective asset 42a-c as the scene (i.e. map) is panned, tilted or zoomed, or as the assets 42a-c move around a scene.

In step S404, the computer-readable tags 40 are read by the reader 8 coupled to the analytics device 10. The relative locations of the computer-readable tags 40 are stored in the memory of the analytics device 10 such that they can be represented in corresponding locations on the analytics display 12. The computer-readable tags 40 are decoded into data that can be processed by the analytics device 10. One computer-readable tag 40 may be associated with the scale of the map being displayed on the main display 4. By decoding this computer-readable tag 40, the analytics device 10 is able to determine how far apart each asset 42a-c (and consequently its radio) is in real terms.

In step S406, the unclassified data 44a-c associated with the respective computer-readable tags 40a-c is identified by the analytics device 10. This may comprise retrieving the unclassified data 44a-c from a database within the analytics device 10 using a decoded URL. Alternatively, the step S406 may comprise processing a decoded text string to isolate the items of data within the string. For example, the computer-readable tag 40a, when decoded, may indicate that a truck is present on the main display 4. The analytics device 10 is configured to use this data to determine that a particular type of radio is present. This may be achieved by looking up the communications equipment on board the truck in a database, such as a database local to the analytics device 10 or on the internet. This unclassified communications data (i.e. radio type) can then be used, in conjunction with other communications data, to create a network configuration map.

In step S408, the unclassified data 44 is displayed on the analytics display 12 using the stored relative locations of the computer-readable tags 40. Therefore, as the assets 42 move relative to each other on the main display 4, the unclassified data 44 moves correspondingly on the analytics display 12. In alternative embodiments, each unclassified data 44a-c item, or group thereof, is associated with a marker which moves around the analytics display 12 to mimic the movement of the associated asset 42a-c on the main display 4.

While the terms “secure”, “unsecure”, “classified” and “unclassified” have been used as labels to delineate the two types of data being processed, it would be appreciated that these are intended to be relative terms. The term “unclassified data” is used to indicate data which requires fewer security restrictions when compared with the “classified data” (such as who can handle it or how it is handled), but it would be appreciated that it would be within the scope of the invention for the unclassified data to have some form of classification or restriction provided it is lower than that of the “classified data”.

Where, in the foregoing description, integers or elements are mentioned that have known, obvious, or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as optional do not limit the scope of the independent claims. Moreover, it is to be understood that such optional integers or features, while of possible benefit in some embodiments of the disclosure, may not be desirable, and can therefore be absent, in other embodiments.

1. An analyzing and presenting device comprising:
an analytics device component and a presenting device component;
said presenting device component comprising:
a presenting storage means comprising first data and second data, wherein the first data is of a higher security classification than the second data;
a presenting controller configured to generate a first computer-readable tag based on the second data; and
image generation means configured to generate an image for display on a presenting display apparatus, the image comprising the first data and the first computer-readable tag,
said analytics device component comprising:
a reader for reading a plurality of computer-readable tags from a first analytics display apparatus;
storage means for storing the relative location of each of the computer-readable tags on the first analytics display apparatus;
an analytics controller configured to decode the plurality of computer-readable tags and identify data associated therewith; and
a second analytics display apparatus for displaying the data and the relative location of the computer-readable tags.

2. The device according to claim 1, wherein the image generation means is arranged to substantially co-locate the first data and the first computer-readable tag on the presenting display apparatus.

3. The device according to claim 1, wherein the image generation means comprises a projector for projecting the first computer-readable tag on to the presenting display apparatus.

4. The device according to claim 1, wherein the first data comprises map coordinates for an asset, and wherein the image comprises a map having the asset and first computer-readable tag displayed thereon.

5. The device according to claim 4, wherein the presenting controller is configured to generate a second computer-readable tag representing the scale of the map in the image, and wherein the image comprises the second computer-readable tag.

6. The device according to claim 1, wherein the second data comprises communication equipment data for an asset and/or a type of the asset.

7. The device according to claim 1, wherein the first computer-readable tag is based on a unique record locator for the second data within a database.

8. The device according to claim 1, wherein the first computer-readable tag is an encoded text string representing the second data.

9. (canceled)

10. The device according to claim 1, wherein at least one computer-readable tag is an encoded representation of a map scale, and wherein the analytics controller is configured to determine the represented distance between the computer-readable tags based on the map scale.

11. The device according to claim 1, wherein the data is communications network management data.

12. (canceled)

13. (canceled)

14. A method of analyzing and presenting secure data, the method comprising:
storing first data and second data, wherein the first data is of a higher security classification than the second data;
generating a first computer-readable tag based on the second data; and
generating an image for display on a presenting display apparatus, the image comprising the first data and the first computer-readable tag:
reading a plurality of computer-readable tags from a first display apparatus;
storing the relative location of each of the computer-readable tags on the first display apparatus;
decoding the plurality of computer-readable tags and identifying data associated therewith; and
displaying the data and the relative location of the computer-readable tags.

15. The method according to claim 14, comprising co-locating the first data and the first computer-readable tag on the presenting display apparatus.

16. The method according to claim 14, comprising projecting the first computer-readable tag on to the presenting display apparatus.

17. The method according to claim 14, wherein the first data comprises map coordinates for an asset, and wherein the image comprises a map having the asset and first computer-readable tag displayed thereon.

18. The method according to claim 17, comprising generating a second computer-readable tag representing the scale of the map in the image, and wherein the image comprises the second computer-readable tag.

19. (canceled)

20. The method according to claim 14, comprising determining the represented distance between the computer-readable tags based on a map scale, wherein at least one computer-readable tag is an encoded representation of the map scale.

21. A method of presenting and analysing data, the method comprising:
displaying first data and at least one computer-readable tag on a display apparatus, the first data having a higher security classification than second data on which the computer-readable tag is based;
reading the at least one computer-readable tag from the display apparatus; and
decoding the at least one computer-readable tag, identifying data associated therewith and displaying the data.

22. (canceled)
